(19) United States
(12) Patent Application Publication
(10) Pub. No.: US 2024/0383498 A1
(43) Pub. Date: Nov. 21, 2024

(54) MULTI-NODE COMPUTATIONAL ARCHITECTURE FOR CONTROL OF AUTONOMOUS VEHICLES

(71) Applicant: TuSimple, Inc., SAN DIEGO, CA (US)

(72) Inventors: Junbo JING, San Diego, CA (US); Chunan HUANG, San Diego, CA (US)

(21) Appl. No.: 18/662,833

(22) Filed: May 13, 2024

Related U.S. Application Data
(60) Provisional application No. 63/502,355, filed on May 15, 2023.

(51) Int. Cl. B60W 60/00; B60W 30/182; B60W 50/00; B60W 50/02

(52) U.S. Cl. CPC B60W 60/001; B60W 30/182; B60W 50/0205; B60W 2050/0002; B60W 2420/403; B60W 2420/408; B60W 2520/06

(57) ABSTRACT

An example method of controlling a vehicle using a multi-node computational architecture includes receiving, by a first computational node, waypoints and vehicle states, and generating a first control command set for motion of the vehicle in a lateral direction with a first complexity and a second control command set for motion in a longitudinal direction with a second complexity that is less than the first complexity. A second computational node, operating in parallel with the first computational node, is used to generate a third control command set for motion in the longitudinal direction with the first complexity. The method further includes selecting, by a control arbitrator and based on the vehicle states and health status indications of the first and second computational nodes, either the second control command set or the third control command set, and outputting the selected control command set, which is used to control the vehicle.

### CROSS-REFERENCE TO RELATED APPLICATION

This application claims priority to and the benefit of U.S. Provisional Application 63/502,355, filed on May 15, 2023, the disclosure of which is hereby incorporated by reference herein in its entirety.

### TECHNICAL FIELD

This document generally relates to controlling vehicles, and in particular, to controlling a vehicle using a multi-node computational architecture.

### BACKGROUND

Autonomous vehicle navigation is a technology for sensing the position and movement of a vehicle and based on the sensing, autonomously control the vehicle to navigate towards a destination. Autonomous vehicle control and navigation can have important applications in transportation of people, goods, and services. Accurate control and navigation in autonomous vehicles rely on reliable computational nodes, which may be implemented in a redundant manner. Reliable computational nodes, which are used to control vehicle steering are paramount for the safety of the vehicle and its passengers, as well as people and property in the vicinity of the vehicle, and for the operating efficiency of driving missions.

### SUMMARY

Devices, systems, and methods for using a multi-node computational architecture to control autonomous vehicles are described. In an example, this is achieved by using redundant computational nodes that compute a driving trajectory with varying degrees of complexity, and selecting one of the trajectories and/or actuation command sets based on the operating status of the computational nodes. The described embodiments deploy the multi-node computational architecture, which results in achieving better fuel economy and meeting system safety redundancy and latency requirements.

In an aspect, a system for controlling a vehicle includes a first computational node, a second computational node, a control arbitrator, and a vehicle controller. The first computational node is configured to receive a plurality of planner waypoints and a plurality of states for the vehicle, and includes a controller configured to receive the plurality of planner waypoints and the plurality of states and generate, using a model predictive control framework, (a) a first control algorithm for motion of the vehicle in a lateral direction, (b) a second control algorithm for motion of the vehicle in a longitudinal direction, and (c) a model predictive control reference that is decomposable into a lateral control reference and a longitudinal control reference by the model predictive control framework, wherein the first control algorithm is decoupled from the second control algorithm. The first computational node further includes (a) a first controller configured to generate, based on the first control algorithm, a first trajectory and a first control actuation command set for the motion of the vehicle in the lateral direction, wherein the first trajectory and the first control actuation command set is generated using an optimization solver with a first complexity, and (b) a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity. The second computational node is configured to receive the plurality of planner waypoints, the plurality of states for the vehicle, and the model predictive control reference that is received with a first delay. In this aspect, the second computational node includes a third controller configured to generate a third trajectory and a third control actuation command set for the motion of the vehicle in the longitudinal direction, wherein the third trajectory and the third control actuation command set is generated using the optimization solver with the first complexity. The control arbitrator of the system is configured to receive the plurality of states for the vehicle, the second control actuation command set, and the third control actuation command set, select, based on at least the plurality of states for the vehicle and health status indications of the first and second computational nodes, either the second control actuation command set or the third control actuation command set, and output the selected control actuation command set. The vehicle controller configured to receive, subsequent to a second delay, the first control actuation command set and the selected control actuation command set, and control the vehicle based thereon.

In another aspect, a method for controlling a vehicle includes receiving, by a first computational node, a plurality of waypoints and a plurality of states for the vehicle. The first computational node comprises a controller that is configured to generate, based on the plurality of waypoints and the plurality of states for the vehicle and using a model predictive control framework, a first control algorithm for motion of the vehicle in a lateral direction and a second control algorithm for motion of the vehicle in a longitudinal direction. The first computational node is further configured to generate (a) a first trajectory and a first control actuation command set for the motion of the vehicle in the lateral direction based on using an optimization solver with a first complexity and (b) a second trajectory and a second control actuation command set for the motion of the vehicle in the longitudinal direction based on using a high reliability solver with a second complexity that is less than the first complexity. The method includes generating, by a second computational node that operates in parallel with the first computational node, a third trajectory and a third control actuation command set for the motion of the vehicle in the longitudinal direction based on using the optimization solver with the first complexity. Then, the method further includes selecting, by a control arbitrator and based on the plurality of states for the vehicle and health status indications of the first and second computational nodes, either the second control actuation command set or the third control actuation command set, and outputting the selected control actuation command set, and controlling, by a vehicle controller, the vehicle based on the first control actuation command set and the selected control actuation command set.

In yet another aspect, a system for controlling a vehicle includes a pair of computational nodes, a control arbitrator, and a vehicle controller. Each of the pair of computational nodes comprises a controller configured to receive a plurality of planner waypoints and a plurality of states for the vehicle and generate, using a model predictive control framework, (a) a first control algorithm for motion of the vehicle in a lateral direction, (b) a second control algorithm for motion of the vehicle in a longitudinal direction. In this aspect, a first computational node of the pair of computational nodes comprises (a) a first controller configured to generate, based on the first control algorithm, a first trajectory and a first control actuation command set for the motion of the vehicle in the lateral direction, wherein the first trajectory and the first control actuation command set is generated using an optimization solver with a first complexity, (b) a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity. A second computational node of the pair of computational nodes comprises (a) a third controller configured to generate, based on the first control algorithm, a third trajectory and a third control actuation command set for the motion of the vehicle in the lateral direction, wherein the third trajectory and the third control actuation command set is generated using the high reliability solver with the second complexity, (b) a fourth controller configured to generate, based on the second control algorithm, a fourth trajectory and a fourth control actuation command set for the motion of the vehicle in the longitudinal direction, wherein the fourth trajectory and the fourth control actuation command set is generated using the optimization solver with the first complexity. Herein, the control arbitrator is configured to select, based on at least the plurality of states for the vehicle and health status indications of the pair of computational nodes, either the first control actuation command set or the third control actuation command set, and output a first selected control actuation command set, and select, based on at least the plurality of states for the vehicle and health status indications of the pair of computational nodes, either the second control actuation command set or the fourth control actuation command set, and output a second selected control actuation command set. The vehicle controller is configured to receive the first selected control actuation command set and the second selected control actuation command set, and control the vehicle based thereon.

In yet another aspect, the methods described in this document are embodied in the form of processor-executable code and stored in a computer-readable program medium.

In yet another aspect, a device that is configured or operable to perform the methods described in this document is disclosed. The device may include a processor that is programmed to implement this method.

The above and other aspects and features of the disclosed technology are described in greater detail in the drawings, the description, and the claims.

### BRIEF DESCRIPTION OF THE DRAWINGS

FIG. 1 shows a block diagram of an example vehicle ecosystem in which an in-vehicle control computer located in the vehicle comprises an interface to control the multi-node computational architecture in the vehicle.

FIG. 2 shows a block diagram of an example dual node architecture.

FIG. 3 shows a block diagram of another example dual node architecture.

FIG. 4 shows a flowchart for the operation for an example arbitrator in the dual node architecture shown in FIG. 2.

FIG. 5 shows an example timing assessment for input-output time delays.

FIG. 6 shows an example of parallel processing in the dual node architecture shown in FIG. 2.

FIG. 7 shows an example plot that demonstrates the delay compensation process.

FIG. 8 shows a flowchart for an example method of controlling a vehicle.

FIG. 9 shows a flowchart for another example method of controlling a vehicle.

FIG. 10 shows an example of a hardware platform that can implement some methods and techniques described in the present document.

### DETAILED DESCRIPTION

The transportation industry has been undergoing considerable changes in the way technology is used to control the operation of vehicles. As exemplified in the automotive passenger vehicle, there has been a general advancement towards shifting more of the operational and navigational decision making away from the human driver and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e.g., maintaining a safe following distance and automatic braking), the safety-protecting warnings of some vehicles (e.g., blind-spot indicators in side-view mirrors and proximity sensors), as well as case-of-use operations (e.g., autonomous parallel parking).

Different types of autonomous vehicles have been classified into different levels of automation under the Society of Automotive Engineers' (SAE) J3016 standard, which ranges from Level 0 in which the vehicle has no automation to Level 5 (L5) in which the vehicle has full autonomy. In an example, SAE Level 4 (LA) is characterized by the vehicle operating without human input or oversight but only under select conditions defined by factors such as road type or geographic area. In order to achieve SAE L4 autonomy, a multi-node computational architecture is a necessity.

A multi-node computational architecture may enable safe and reliable use of autonomous vehicles regardless of their level of autonomy, especially for Level 4 (L4) autonomous systems as defined in SAE J3016, in which the automation is configured to operate without human intervention under specific conditions, when all of the conditions are met, but wherein a human still has an option to override the autonomous driving system. For L4 systems, the multi-node computational architecture may provide a level of robustness that enables it to handle any kind of control software failure to ensure the safety of the autonomous vehicle and both persons and property in the area surrounding the vehicle.

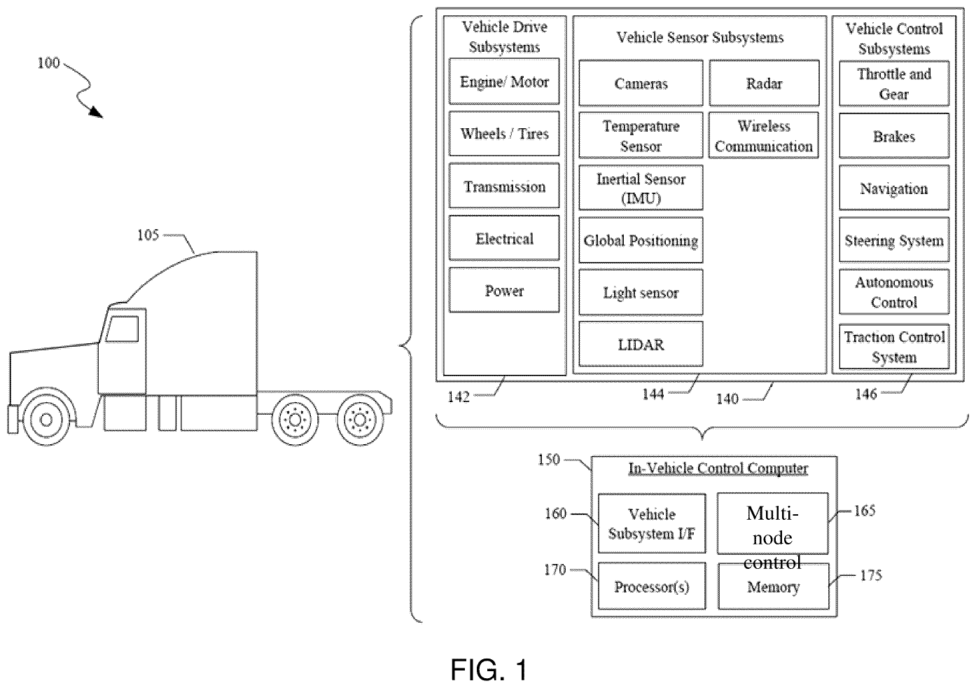

FIG. 1 shows a block diagram of an example vehicle ecosystem 100 in which an in-vehicle control computer 150 located in the autonomous vehicle 105 includes an interface to the power distribution unit of the vehicle. As shown in FIG. 1, the autonomous vehicle 105 may be a semi-trailer truck. The vehicle ecosystem 100 includes several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network controller to communicate with devices in the vehicle subsystems 140.

The autonomous vehicle 105 may include various vehicle subsystems that support of the operation of autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems or one or more components or devices can be removed. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, a laser range finder/LiDAR unit, a RADAR unit, and/or a wireless communication unit (e.g., a cellular communication transceiver). The vehicle sensor subsystem 144 may also include sensors configured to monitor internal systems of the autonomous vehicle 105 (e.g., an 02 monitor, a fuel gauge, an engine oil temperature, etc.,). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. The RADAR unit may represent a system that utilizes radio signals to sense objects within the environment in which the autonomous vehicle 105 is operating. In some embodiments, in addition to sensing the objects, the RADAR unit may additionally be configured to sense the speed and the heading of the objects proximate to the autonomous vehicle 105. The laser range finder or LiDAR unit may be any sensor configured to sense objects in the environment in which the autonomous vehicle 105 is located using lasers. The LiDAR unit may be a spinning LiDAR unit or a solid-state LiDAR unit. The cameras may include one or more cameras configured to capture a plurality of images of the environment of the autonomous vehicle 105. The cameras may be still image cameras or motion video cameras.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or an autonomous control unit. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an anti-lock brake system (ABS) that can prevent the brakes from locking up when the brakes are applied. Additionally, the brake unit may include an engine braking system. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR, the cameras, and/or other vehicle subsystems to determine the driving path or trajectory for the autonomous vehicle 105.

The traction control system (TCS) may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for controlling the multi-node computational architecture, whose interface 165 is part of the in-vehicle control computer 150, as explained in this document. For instance, the processor 170 executes the operations associated with the multi-node computational architecture via the multi-node control interface 165. The operations of the multi-node computational architecture are further described in this patent document.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

In some embodiments, the described methods, devices, and systems are directed to SAE LA autonomous driving dynamic control systems, which cover SAE L1-L3 driving assistance applications, semi-autonomous systems, and expand to the full coverage of vehicle dynamic control needs in real-world driving, which includes lane changes, merging into traffic, navigating highway on/off ramps, passing through intersections, maneuvering through congested traffic, parking, and docking operations, etc. In contrast to conventional systems that focus on a single control target, embodiments of the disclosed technology are part of the processing of a control mission that involves control targets defined in multiple dimensions and which are typically time varying.

Embodiments of the disclosed technology provide methods and systems for using a multi-node computational architecture for controlling autonomous vehicles. The multi-node computational architecture of the described embodiments advantageously provides increased fuel economy, redundant control that results in very high reliability, and an increase in the accuracy of trajectory control for the autonomous vehicle.

The described embodiments support multiple resource-intensive optimization processes running in parallel with aligned time synchronization, which solve for optimal vehicle autonomy control commands. In some embodiments, running multiple optimization processes are necessary to achieve the requirements of L4 autonomous driving control, e.g., motion control precision, safety risk management, and advanced performance such as fuel economy. In particular, the fuel economy control optimization process typically demands as many computational resources as are available, which results in fuel economy improvement growing monotonically with the available computational resources. This creates a conflict with other control applications, which also need to access to the computational resources. For example, with regard to resource assignments when computations are being handled in a cascaded process, lateral motion control through steering control uses a vehicle control solving process that is given a fixed amount of computation time budget at a required system update rate, for safety reasons. This hard requirement for computational resources by the vehicle control solving process reduces available computational resources that could be used to improve fuel economy. Embodiments of the disclosed technology are configured to optimally run both processes for any computational resources they can access.

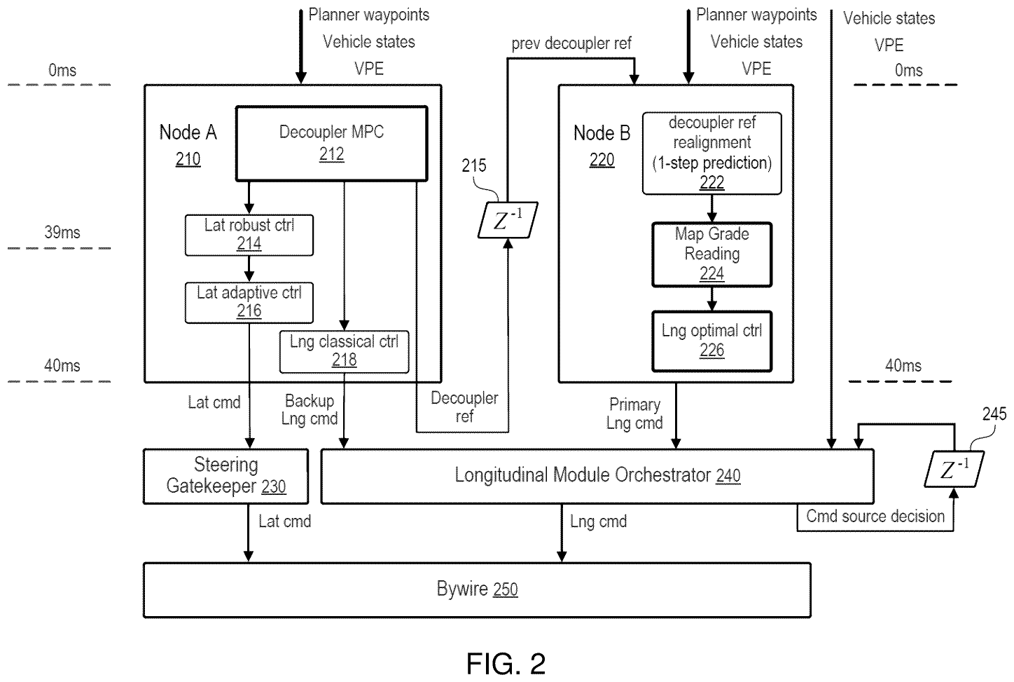

The parallel computing structures also add necessary redundancy to the system. For example, by implementing the backup controller and primary controller in parallel, the system can remain functionally complete at all times and is able to consistently output commands to ensure safety. This is the foundation of the safety guarantee of an autonomous system. In particular, advanced yet higher risk computations are implemented in one of the computational nodes (e.g., denoted as “Node B” in FIG. 2), which include map previewing and large-scale optimization processes. These computational processes calculate the controller command set with enhanced (or preferable) functionalities for L4 autonomous driving, including fuel economy optimization and advanced risk management, which can be allowed to run with an unstable frequency but without creating immediate safety hazard. Meanwhile, simple yet minimal risk computations are put into a parallel separate node (e.g., denoted as “Node A” in FIG. 2), which calculates the controller command set for essential functionalities required by autonomous driving, such as basic tracking, while not being allowed to fail (by having an inconsistent frequency when outputting or reporting). Should a failure happen at Node A, autonomous operation will be commanded to enter into a Minimal Risk Condition (MRC) handling, such that the redundancy system of the whole autonomous driving stack will take over, and bring the vehicle to a full stop by either emergency braking or pulling over to the roadside. Determining whether controller command results from either Node B or Node A are used, and determining whether Node A has failed and demands MRC handling, is performed by a third separate arbitrating or orchestrating node.

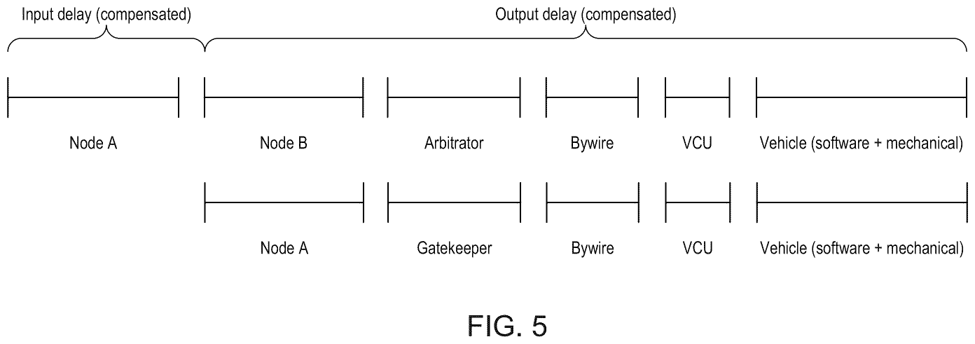

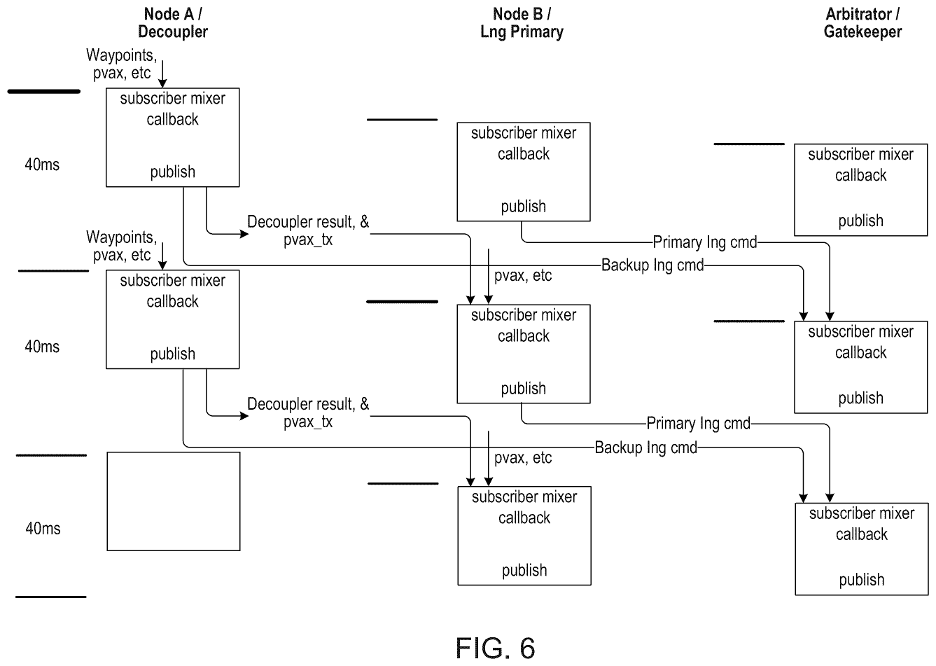

Furthermore, the described embodiments provide a set of delay handling mechanisms (e.g., as described in the context of FIGS. 5 and 6) that identify and compensate for delays due to input communication, computation (al) time (e.g., the actual time spent by the CPU (or GPU) computing for a specific task), output communication, and execution time (e.g., the total time required to complete the specific task, including disk and memory access, input/output activities, and so on). Such delay compensation methods not only improves overall control accuracy, but also reduce the required safety buffer on emergency condition due to improved control system reaction time, which improves the robustness of survival and operation when encountering complicated unknown traffic and road conditions in an autonomous driving mode.

Existing implementations typically have a single point of failure and time budget shortages in control modules due to cascaded processing in a single computational node. In traditional systems, all control algorithms are run in series one after another one, including lateral control and longitudinal control problems, and the primary control and the backup control algorithms. If one of them crashes or fails, the entire control module fails, which is a canonical example of a single point of failure. Embodiments of the described technology provide a multi-node structure that assigns the primary and the backup algorithms for longitudinal and lateral control to separate computational nodes, and uses an arbitrator node to monitor the health of the each of the computational nodes. Therefore, if there is a software crash or an irregular result output from the control node running primary algorithms, the arbitrator node will switch to use the control node executing the backup algorithms, thereby maintaining the functionality of the vehicle control module.

Secondly, the L4 autonomous control module requires running multiple time-consuming algorithm processes for control performance enforcement, e.g., optimization solvers and/or map services. Stacking these computationally expensive processes in sequence within one thread will typically result in an unreasonable total computation time budget, which directly conflicts with the control update frequency requirements necessitated by safety protocols. To resolve these conflicts, the described embodiments provide a multi-node parallel computation structure that assigns those computation intensive processes to different nodes, with balanced time budget needs and synchronized result delivery handling. Additional algorithmic processes can be supported by adding additional parallel threads, while maintaining the total time budget and keeping the update frequency unchanged.

In some embodiments, and as shown in FIG. 2, the dual node architecture includes a first computational node (210, denoted “Node A”) and a second computational node (220, denoted “Node B”). Both the computational nodes receive planner waypoints, vehicle states, and vehicle parameter estimates (VPE) that provide online estimated longitudinal dynamic model parameters that quantify the vehicle's acceleration response per given torque input, road grade (e.g., the incline of the road), and speed status. As discussed above, Node A 210 and Node B 220 implement different functionalities to ensure that provided redundancy can meet the stringent safety requirements of L4 autonomous operation of autonomous vehicles.

Node A 210 includes a decoupler that uses a model predictive control (MPC) framework. The decoupler MPC 212 receives the planner waypoints, vehicle states, and VPE, and generates a first control algorithm for lateral motion of the vehicle and a second control algorithm for the longitudinal motion of the vehicle. The decoupler MPC 212 generates the first and second control algorithms in a “decoupled” manner such that the two control algorithms can be solved independently. The first control algorithm for the lateral motion of the vehicle is solved by the lateral robust control module 214 and the lateral adaptive control module 216, which generate control commands for the lateral motion of the vehicle (denoted “Lat cmd” in FIG. 2). The second control algorithm for the longitudinal motion of the vehicle is solved by the longitudinal classical control module 218, which generates control commands for the longitudinal motion of the vehicle (denoted “Backup Lng cmd”).

In this example, Node A is implemented such that the lateral robust control module 214 and the lateral adaptive control module 216 generate the control commands for the lateral motion of the vehicle with a first complexity, and the longitudinal classical control module 218 generates control commands for the longitudinal motion of the vehicle with a second complexity that is less than the first complexity. In an example, the lateral robust control module 214 and the lateral adaptive control module 216 use an optimization solver, whereas the longitudinal classical control module 218 uses a high runtime reliability solver with a complexity that is less than the complexity of the optimization solver. Herein, Node A generates a “complete” or “full complexity” (or “optimal”) solution for the lateral motion (e.g., using the optimization solver), but only a “backup” or “partial complexity” solution for the longitudinal motion (e.g., using the high runtime reliability solver with lower complexity). In an example, the optimization solver is implemented using a graphics processing unit (GPU) with a high bit-width for the computations, whereas the high runtime reliability solver is implemented using lower bit-width algorithms and stricter rules for numerical convergence. In this manner, Node A is configured to meet the timing requirements of the overall system (e.g., a maximum of 40 ms, as shown in FIG. 2) when generating commands (e.g., steering, throttle, and/or brake commands) for both the lateral motion and the longitudinal motion, as well as a reference tracking trajectory (denoted “Decoupler ref” in FIG. 2 and generated by the decoupler MPC 212) for Node B. In some embodiments, the reference trajectory is decomposed into a longitudinal tracking reference trajectory (or a longitudinal control reference sent to Node B) and a lateral tracking reference trajectory. In some embodiments, Node A has the same refresh rate as Node B. Alternatively, the described parallel architecture supports Node A having a faster refresh rate than Node B in other embodiments.

Node B 220 receives the planner waypoints, vehicle states, and VPE, as well as a reference from the decoupler MPC 212 in Node A 210 after a computation and communication delay that is denoted using delay block 215. Node B includes a decoupler reference alignment module 222 (which can be implemented as a 1-step prediction), a map grade reading module 224, and a longitudinal optimal control module 226. In an example, the second control algorithm for the longitudinal motion of the vehicle, which is generated by the decoupler MPC 212 from the previous frame stored by block 215, is received by Node B 220, and realigned using the decoupler reference alignment module 222. The modules of Node B are configured to process the planner waypoints, vehicle states, and VPE, as well as a reference from the decoupler MPC 212 (e.g., the longitudinal control reference), and generate control commands for the longitudinal motion of the vehicle (denoted “Primary Lng cmd” in FIG. 2). Different from the “Backup Lng cmd” that is generated by Node A with reduced complexity, the “Primary Lng cmd” output is generated as a “complete” or “full complexity” (or “optimal”) solution for the longitudinal motion of the vehicle.

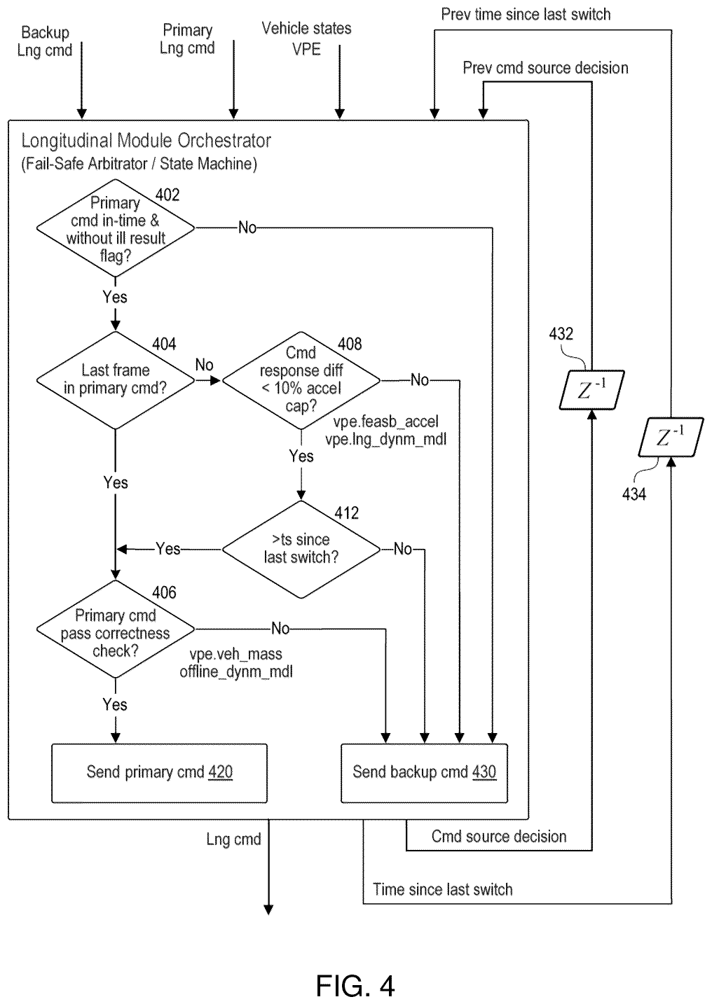

The control commands for the lateral motion of the vehicle (“Lat cmd”) are routed through the steering gatekeeper 230 to the drive-by-wire module 250 (denoted “bywire” in FIG. 2), which implements the control commands. Because control commands for both the “backup” and “complete” solutions for the longitudinal motion are generated by Node A and Node B, respectively, both solutions are routed to the longitudinal module orchestrator 240, which selects one of the set of control commands for the longitudinal motion, and then routes the selected control commands to the bywire 250. An example of the operation of the longitudinal module orchestrator 240 is further detailed in the context of FIG. 4, and includes relaying the command source decision (using delay block 245) from the previous frame so it can be fed back to the longitudinal module orchestrator 240. The steering gatekeeper 230 protects irregular steering commands from being sent from Node A 210 to bywire 250. In an example, this is achieved by checking the scale and consistency of the values generated by Node A, and applying range protection and irregular value (or statistical outlier) rejection. The longitudinal orchestrator 240 uses replayed command source decisions from the previous frame to avoid causing frequent decision changes of trivial safety values, which lead to a degraded ride quality.

The example dual computational node architecture shown in FIG. 2 generates primary control commands for the lateral motion of the vehicle, and both primary and backup control commands for the longitudinal motion of the vehicle. In other embodiments, the dual computational node architecture in FIG. 2 is configured to generate primary control commands for the longitudinal motion of the vehicle, and both primary and backup control commands for the lateral motion of the vehicle. In this alternative embodiment, the longitudinal module orchestrator 240 is replaced by a lateral module orchestrator 240.

Generating both the primary and backup control commands adds a level of redundancy that enables autonomous vehicles using the dual computational node architecture, shown in FIG. 2, to remain operational, consistently and reliably. Furthermore, generating primary control commands for one direction of motion (lateral or longitudinal) and backup control commands for the other direction of motion (longitudinal or lateral, respectively) in a single computational node enables that node to use more computational time and resources that leads to solutions (e.g., control commands) that achieve better fuel economy gains.

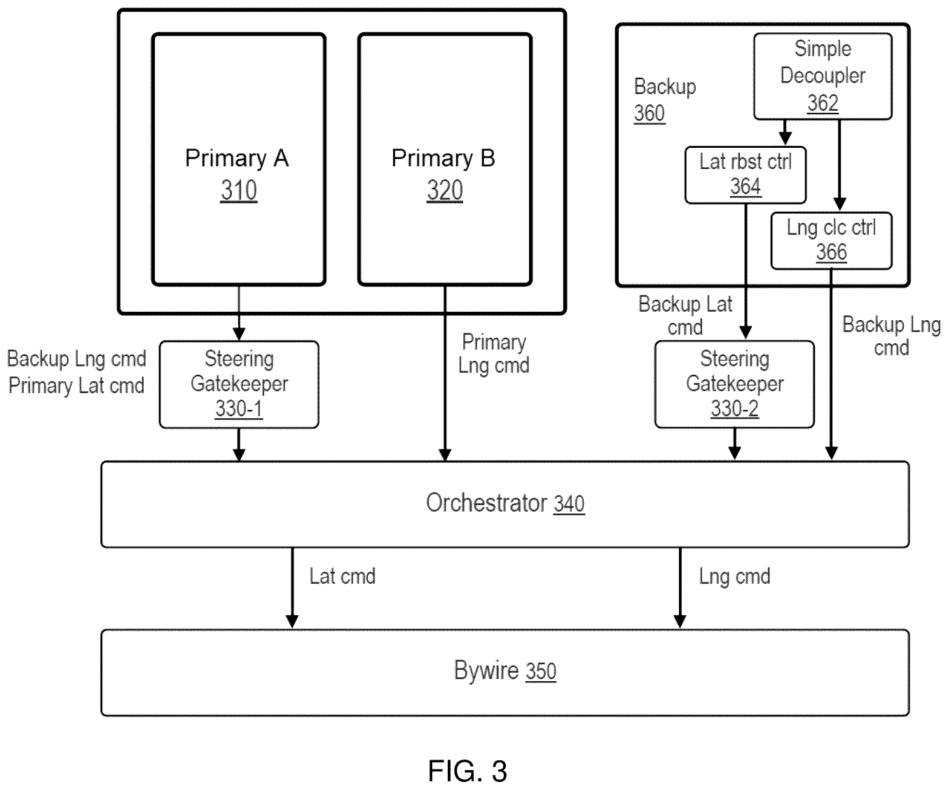

FIG. 3 is a block diagram of an example alternative dual computational node architecture in which a first computational node includes Primary A module 310 and Primary B module 320 that are configured to generate the “complete” or “full complexity” solutions for both the lateral and longitudinal motions of the vehicle. The backup computational node 360 generates the “backup” or “partial complexity” solutions for both the lateral and longitudinal motions of the vehicle. As in the architecture shown in FIG. 2, the steering gatekeeper for each of the computational nodes (denoted 330-1 and 330-2 for the first and backup computational nodes, respectively) and the orchestrator 340 select and route the appropriate control commands for the lateral motion and the longitudinal motion to the bywire 350, which is configured to implement the control commands.

FIG. 4 is a block diagram showing an example of an arbitrator 400 that can be implemented by, for example, the longitudinal module orchestrator 240 in FIG. 2 or the orchestrator 340 in FIG. 3. In the example shown in FIG. 4, the arbitrator 400 receives the backup longitudinal command, the primary longitudinal command, and state or parametric information (that includes the vehicle states and vehicle parameter estimation (VPE)). At decision block 402, the arbitrator 400 determines whether the primary control command is received in-time and without any adverse status conditions associated with the nodes. In an example, the adverse status conditions that are considered by the arbitrator 400 include the solver exit condition tag (e.g., did the solver exit after converging to a solution? Did the solver encounter any numerical instability?) and the consistency of the computation time. If either of these conditions fail (“NO” at decision block 402), the arbitrator 400 sends backup control commands (operation 430) to the bywire. Alternatively, if both the conditions are satisfied (“YES” at decision block 402), and the last frame in the primary command is encountered (“YES” at decision block 404), and the primary command passes the correctness check (“YES” at decision block 406), then the arbitrator 400 sends primary control commands (operation 420) to the bywire.

In some embodiments, decision switching from using primary control commands to using backup control commands is always instantaneous when any failure indication is received from the primary controller. However, decision switching from using backup control commands to using primary control commands, with the assumption that the primary controller has recovered to a healthy state, needs to go through checks to ensure the primary commands are consistent with backup commands, and if a sufficient amount of time has elapsed since the last decision switch, which is indicative of the primary controller's continuous and consistent healthy operation over that elapsed time. This operation of the primary controller over the elapsed time requires memory blocks to record the previous frame's source decisions, and the total time in backup mode since the last switch. The correctness of the primary control commands can be determined by cross referencing the model being used in the backup controller, where the control commands are being passed through an offline vehicle dynamic model with a vehicle mass input, and checked to ensure that the predicted vehicle acceleration matches with the planner waypoints' demanded acceleration.

However, if the last frame in the primary command is not encountered (“NO” at decision block 404), then the arbitrator 400 determines, at decision block 408, whether a difference between the predicted vehicle acceleration based on primary control command and predicted vehicle acceleration based on the backup control command is less than a first threshold (e.g., predetermined threshold of 10% in FIG. 4). Herein, the predicted vehicle acceleration based on the backup control command is relative to the vehicle's instantaneous acceleration capacity, which is determined by the vehicle parameter estimation (VPE) module. If the difference is greater than the first threshold (“NO” at decision block 408), then the arbitrator 400 sends backup control commands (operation 430) to the bywire.

If the difference is less than the first threshold (“YES” at decision block 408), the arbitrator 400 determines, at decision block 412, whether the time since the last switch (e.g., between the bywire using the primary command or the backup command) is greater than a second threshold. In an example, the second threshold is a predetermined value. In another example, the second threshold is a dynamic threshold that is based on the current scenario. In yet another example, the second threshold is based on a previous value of the threshold (e.g., determined based on “Time since last switch” that is fed back via delay block 434).

If the time since the last switch is less than the second threshold (“NO” at decision block 412), then the arbitrator 400 sends the backup control commands (operation 430) to the bywire. If the time since the last switch is greater than the second threshold (“YES” at decision block 412), then the arbitrator 400 determines whether the primary control commands pass the correctness check (decision block 406). As discussed above, although the longitudinal module orchestrator is shown in FIG. 4, a similar lateral module orchestrator can be implemented in the alternative. Similarly, the arbitration logic shown in FIG. 4 is modified to support the dual computational node architecture shown in FIG. 3, wherein both primary and back commands are generated for both lateral and longitudinal motions of the vehicle.

In some embodiments, the state machine of the longitudinal module orchestrator is configured to track the health status of each of the computational nodes, the bywire, and/or the steering gatekeeper, and incorporate that information into the decisions being made with regard to whether the primary or backup control commands should be sent to the bywire.

FIG. 5 shows an example timing assessment for input-output time delays. As shown therein, the input delay typically includes the computational time of the decoupler MPC and the lateral controller, whereas the output delay includes the computational time of the longitudinal controller, the bywire, the vehicle control unit (VCU), and associated software and mechanical delays for controlling the vehicle. As shown in FIG. 5, these delays (which include the delays due to the arbitrator and gatekeeper functions) can be compensated for.

FIG. 6 shows an example of parallel processing in the dual node architecture. The arbitrator (or orchestrator) receives the primary and backup commands for the longitudinal motion of the vehicle because the dual computational node architecture operates in parallel. In the example shown in FIG. 6, each 40 ms period is utilized by each of the modules (e.g., Node A, Node B, and the arbitrator/gatekeeper) to perform their computations in parallel. Furthermore, the input delay due to the longitudinal control processing is addressed by measuring and phase shifting the reference processing time.

In some instances, the vehicle system pipeline inevitably includes a delay from measurement to execution; this delay is relatively constant and can be approximated. The disclosed embodiments pre-compensate for this delay at the controller to improve response timeliness and accuracy. In the example of longitudinal control, this can be addressed in the longitudinal MPC algorithm using a 1-step predictor to re-align the execution time stamp.

In some embodiments, the system time delay exists in three parts:
(1) Measurements to controller
   Signals from CAN bus update with fixed cycles, meaning a cycle's refresh rate introduces a constant time delay. CAN bus signals of different channels have different refresh rates. Sensor before CAN bus also has a delay (such as wheel tachometer).
   The CAN bus signal needs to be interpreted by Vehicle Control Unit (VCU) and then sent through the bywire to the server. A node at the server synchronizes reports of various sources (CAN, GPS, IMU, etc.). The above signal passing process introduces a delay.
   Signal processing at server, such as vehicle speed computed using an extended Kalman filter (EKF), can introduce a delay either due to the node refresh rate or the group delay of the filter algorithm.

Having considered the above factors, a vehicle state report to the controller labeled at t₀ can be a vehicle's real state measurement at t₀−Δtₘₑₐₛᵤᵣₑ, with Δtₘₑₐₛᵤᵣₑ=100 msec. This 100 msec delay can be simulated as a pure delay.
(2) Computational delay at the controller node (CN)
   The controller node refreshes at 25 Hz, which implies that by the time the control command is finalized and being sent out, an assumed to state control command actually locates at t₀+Δt_{CN}. In an example, Δt_{CN}=40 msec.
(3) Control command execution
   The control commands out of the controller node (CN) at server need to be passed to VCU, and then VCU interprets the commands to CAN bus messages to the vehicle, and then the vehicle executes a control command, such as engine combustion torque generation (e.g., with an unknown execution time) or foundation air brake pressure (Δt_{execute}=200 msec). Furthermore, delivering torque from the engine to the wheels needs to go through the long non-rigid driveline (mechanical load), while the subject of planning and control locates on vehicle wheels. Therefore, a final delivery of control command locates at t₂.

Computation delay, communication delay and control command execution delay together make an output delay of approximately (Δt_{CN}+Δtₘₑₐₛᵤᵣₑ+Δt_{execute}) relative to the observed state's true time. This means a state observation sent to the controller node at to actually happened at t₀−Δtₘₑₐₛᵤᵣₑ, and the resulting control actuation will be executed at (t₀+Δt_{CN}+Δtₘₑₐₛᵤᵣₑ+Δt_{execute}). Among these delays, Δtₘₑₐₛᵤᵣₑ and Δt_{CN} are pure delay, whereas Δt_{execute} can be simulated as a lag.

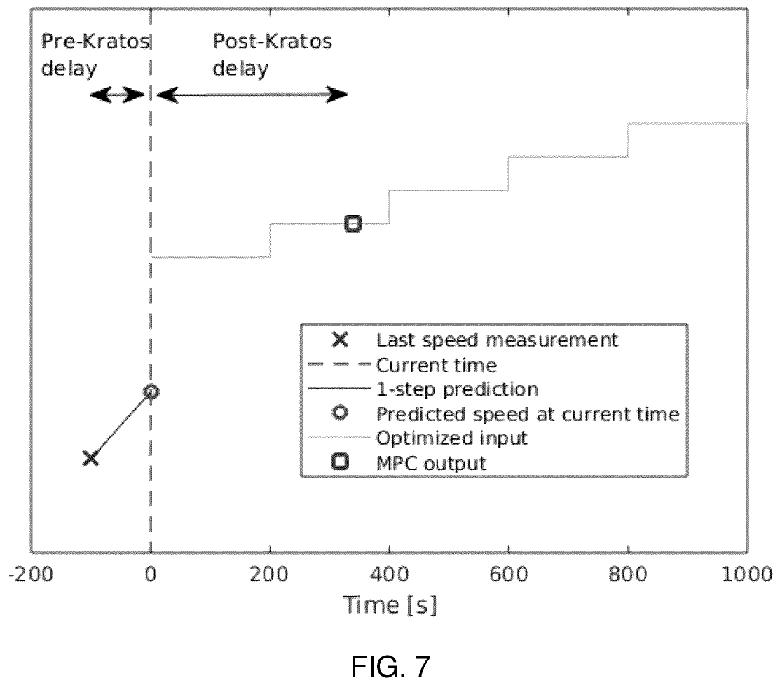

As described above, the delay before the controller node is the measurement delay Δtₘₑₐₛᵤᵣₑ, and after the CN, the delay is the sum of computation delay, communication delay and execution delay, in total (Δt_{CN}+Δtₘₑₐₛᵤᵣₑ+Δt_{execute}), which is shown in FIG. 7. For the pre-CN delay, a one-step prediction is used to estimate the vehicle state (velocity) at current time when the MPC is performed. For the post-CN delay, instead of outputting the optimized actuator input at the first step, an interpolation is performed to make up for the delay.

Embodiments of the disclosed technology provide a system for controlling a vehicle. In the context of FIG. 2, the system includes a first computational node (Node A, 210) configured to receive a plurality of planner waypoints and a plurality of states for the vehicle. The first computational node (210) comprises a controller (212) configured to receive the plurality of planner waypoints and the plurality of states and generate, using a model predictive control framework, a first control algorithm for motion of the vehicle in a lateral direction, a second control algorithm for motion of the vehicle in a longitudinal direction, and a model predictive control reference that is decomposable into a lateral control reference and a longitudinal control reference by the model predictive control framework, and wherein the first control algorithm is decoupled from the second control algorithm. The first computational node (210) further includes a first controller (214, 216) configured to generate, based on the first control algorithm, a first trajectory and a first control actuation command set for the motion of the vehicle in the lateral direction, wherein the first trajectory and the first control actuation command set is generated using an optimization solver with a first complexity, and a second controller (218) configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity. The system further includes a second computational node (Node B, 220) configured to receive the plurality of planner waypoints, the plurality of states for the vehicle, and the model predictive control reference, which is received with a first delay (215) that is representative of the communication and computation delay. The second computational node (220) comprises a third controller (226) configured to generate a third trajectory and a third control actuation command set for the motion of the vehicle in the longitudinal direction, wherein the third trajectory and the third control actuation command set is generated using the optimization solver with the first complexity. The system also includes a control arbitrator (240) configured to receive the plurality of states for the vehicle, the second control actuation command set, and the third control actuation command set, select, based on at least the plurality of states for the vehicle and health status indications of the first and second computational nodes, either the second control actuation command set or the third control actuation command set, and output the selected control actuation command set, and a vehicle controller (250) configured to receive, subsequent to a second delay, the first control actuation command set and the selected control actuation command set, and control the vehicle based thereon.

In some embodiments, the control arbitrator is configured to select the second control actuation command set upon a determination that the health status indication of the second computational node comprises an error condition.

In some embodiments, the control arbitrator is configured to select a minimal risk condition control actuation command set upon a determination that the health status indication of the first computational node comprises an error condition, and wherein the minimal risk condition control actuation command set causes the vehicle to reduce its speed and safely come to a stop.

In some embodiments, the first control algorithm being decoupled from the second control algorithm configures the first controller and the second controller to independently solve the first control algorithm and the second control algorithm, respectively.

In some embodiments, a duration of the first delay or the second delay is based on an input delay and an output delay, wherein the input delay comprises a communication time and a computation time of the first computational node and the output delay comprises a delay associated with electro-mechanical components of the vehicle. The output delay further includes a computation time of the second computational node and a computation time of the trajectory arbitrator.

In some embodiments, the vehicle is an autonomous vehicle is operating in a Society of Automotive Engineers (SAE) Level 4 (L4) automation mode.

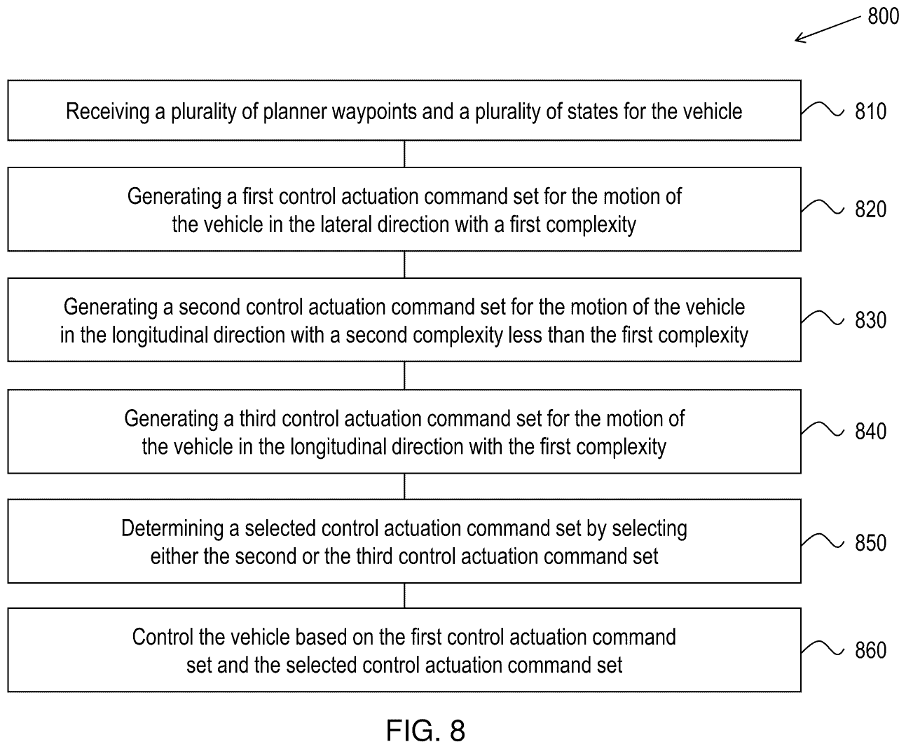

FIG. 8 shows a flowchart for an example method 800 for controlling a vehicle using, for example, the dual node architecture shown in FIG. 2. The method 800 includes, at operation 810, receiving a plurality of planner waypoints and a plurality of states for the vehicle.

The method 800 includes, at operation 820, generating a first control actuation command set for the motion of the vehicle in the lateral direction with a first complexity. In an example, operation 820 is performed by Node A (210), which generates the full-complexity lateral commands (e.g., using an optimization solver).

The method 800 includes, at operation 830, generating a second control actuation command set for the motion of the vehicle in the longitudinal direction with a second complexity less than the first complexity. In an example, operation 830 is performed by Node A, which generates the partial complexity longitudinal commands (e.g., using a high runtime reliability solver with the second complexity).

The method 800 includes, at operation 840, generating a third control actuation command set for the motion of the vehicle in the longitudinal direction with the first complexity. In an example, operation 840 is performed by Node B (220), which generates the full-complexity longitudinal commands.

The method 800 includes, at operation 850, determining a selected control actuation command set by selecting either the second control actuation command set or the third control actuation command set. In an example, operation 850 is performed by the longitudinal module orchestrator 240.

The method 800 includes, at operation 860, control the vehicle based on the first control actuation command set and the selected control actuation command set. In an example, the operation 860 is performed by the bywire 250.

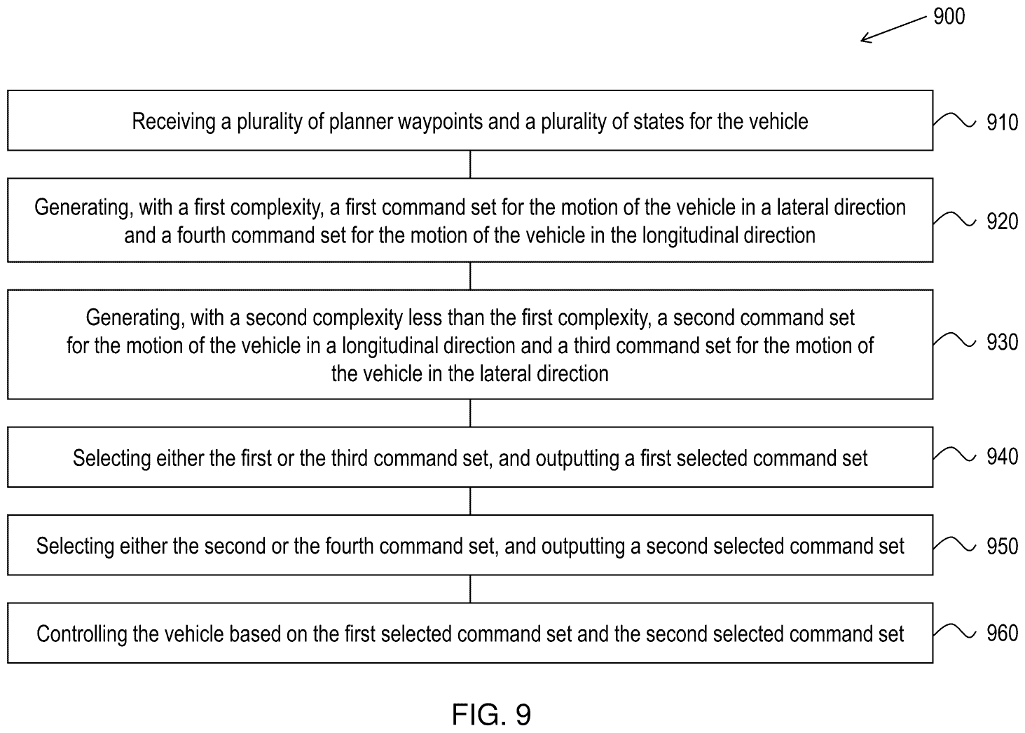

FIG. 9 shows a flowchart for an example method 900 for controlling a vehicle using, for example, the dual node architecture shown in FIG. 3. The method 900 includes receiving a plurality of planner waypoints and a plurality of states for the vehicle (910), generating, with a first complexity, a first command set for the motion of the vehicle in a lateral direction and a fourth command set for the motion of the vehicle in a longitudinal direction (920), generating, with a second complexity less than the first complexity, a second command set for the motion of the vehicle in the longitudinal direction and a third command set for the motion of the vehicle in the lateral direction (930), selecting either the first command set or the third command set, and outputting a first selected trajectory (940), selecting either the second command set or the fourth command set, and outputting a second selected command set (950), and controlling the vehicle based on the first selected command set and the second selected command set (960).

The described embodiments provide, inter alia, the following technical solutions for controlling a vehicle using a dual computational node architecture.
1. A system for controlling a vehicle, comprising: a first computational node configured to receive a plurality of planner waypoints and a plurality of states for the vehicle, wherein the first computational node comprises: a controller configured to receive the plurality of planner waypoints and the plurality of states and generate, using a model predictive control framework, (a) a first control algorithm for motion of the vehicle in a lateral direction, (b) a second control algorithm for motion of the vehicle in a longitudinal direction, and (c) a model predictive control reference that is decomposable into a lateral control reference and a longitudinal control reference by the model predictive control framework, wherein the first control algorithm is decoupled from the second control algorithm; a first controller configured to generate, based on the first control algorithm, a first trajectory and a first control actuation command set for the motion of the vehicle in the lateral direction, wherein the first trajectory and the first control actuation command set is generated using an optimization solver with a first complexity; and a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity; a second computational node configured to receive the plurality of planner waypoints, the plurality of states for the vehicle, and the model predictive control reference, wherein the model predictive control reference is received with a first delay, and wherein the second computational node comprises: a third controller configured to generate a third trajectory and a third control actuation command set for the motion of the vehicle in the longitudinal direction, wherein the third trajectory and the third control actuation command set is generated using the optimization solver with the first complexity; a control arbitrator configured to receive the plurality of states for the vehicle, the second control actuation command set, and the third control actuation command set, select, based on at least the plurality of states for the vehicle and health status indications of the first and second computational nodes, either the second control actuation command set or the third control actuation command set, and output the selected control actuation command set; and a vehicle controller configured to receive, subsequent to a second delay, the first control actuation command set and the selected control actuation command set, and control the vehicle based thereon.
2. The system of solution 1, wherein the first control actuation command set comprises a throttle command set, a brake command set, and a steering command set.
3. The system of solution 1 or 2, wherein the control arbitrator is configured to select the second control actuation command set upon a determination that the health status indication of the second computational node comprises an error condition.
4. The system of solution 1 or 2, wherein the control arbitrator is configured to select a minimal risk condition control actuation command set upon a determination that the health status indication of the first computational node comprises an error condition, and wherein the minimal risk condition control actuation command set causes the vehicle to reduce its speed and safely come to a stop.
5. The system of solution 1 or 2, wherein the first control algorithm being decoupled from the second control algorithm configures the first controller and the second controller to independently solve the first control algorithm and the second control algorithm, respectively.
6. The system of any of solutions 1 to 5, wherein a duration of the first delay or the second delay is based on an input delay and an output delay, wherein the input delay comprises a communication time and a computation time of the first computational node and the output delay comprises a delay associated with electro-mechanical components of the vehicle.
7. The system of solution 6, wherein the output delay further comprises a computation time of the second computational node and a computation time of the control arbitrator.
8. The system of any of solutions 1 to 7, wherein the vehicle is an autonomous vehicle is operating in a Society of Automotive Engineers Level 4 automation mode.
9. A method of controlling a vehicle, comprising: receiving, by a first computational node, a plurality of waypoints and a plurality of states for the vehicle, wherein the first computational node comprises a controller that is configured to generate, based on the plurality of waypoints and the plurality of states for the vehicle and using a model predictive control framework, a first control algorithm for motion of the vehicle in a lateral direction and a second control algorithm for motion of the vehicle in a longitudinal direction; generating, by the first computational node, (a) a first trajectory and a first control actuation command set for the motion of the vehicle in the lateral direction based on using an optimization solver with a first complexity and (b) a second trajectory and a second control actuation command set for the motion of the vehicle in the longitudinal direction based on using a high reliability solver with a second complexity that is less than the first complexity; generating, by a second computational node that operates in parallel with the first computational node, a third trajectory and a third control actuation command set for the motion of the vehicle in the longitudinal direction based on using the optimization solver with the first complexity; selecting, by a control arbitrator and based on the plurality of states for the vehicle and health status indications of the first and second computational nodes, either the second control actuation command set or the third control actuation command set, and outputting the selected control actuation command set; and controlling, by a vehicle controller, the vehicle based on the first control actuation command set and the selected control actuation command set.
10. The method of solution 9, wherein the first control actuation command set comprises a throttle command set, a brake command set, and a steering command set.
11. The method of any of solution 9 or 10, wherein the control arbitrator is configured to select either the second control actuation command set or the third control actuation command set further based on a runtime delay of the second computational node.
12. The method of solution 11, wherein the second control actuation command set is selected upon a determination that the runtime delay is greater than a threshold.
13. The method of any of solutions 9 to 12, wherein using the model predictive control framework enables (a) the first algorithm to be generated for a finite time-horizon that includes a current timeslot and (b) the first trajectory and the first control actuation command set to be generated only for the current timeslot at each timestep.
14. The method of any of solutions 9 to 12, wherein the second computational node generates the third control actuation command set further based on a road grade associated with one or more of the plurality of waypoints.
15. A system for controlling a vehicle, comprising: a pair of computational nodes; a control arbitrator; and a vehicle controller, wherein each of the pair of computational nodes comprises a controller configured to receive a plurality of planner waypoints and a plurality of states for the vehicle and generate, using a model predictive control framework, (a) a first control algorithm for motion of the vehicle in a lateral direction, (b) a second control algorithm for motion of the vehicle in a longitudinal direction, wherein a first computational node of the pair of computational nodes comprises: a first controller configured to generate, based on the first control algorithm, a first trajectory and a first control actuation command set for the motion of the vehicle in the lateral direction, wherein the first trajectory and the first control actuation command set is generated using an optimization solver with a first complexity, a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity, wherein a second computational node of the pair of computational nodes comprises: a third controller configured to generate, based on the first control algorithm, a third trajectory and a third control actuation command set for the motion of the vehicle in the lateral direction, wherein the third trajectory and the third control actuation command set is generated using the high reliability solver with the second complexity, a fourth controller configured to generate, based on the second control algorithm, a fourth trajectory and a fourth control actuation command set for the motion of the vehicle in the longitudinal direction, wherein the fourth trajectory and the fourth control actuation command set is generated using the optimization solver with the first complexity, wherein the control arbitrator is configured to: select, based on at least the plurality of states for the vehicle and health status indications of the pair of computational nodes, either the first control actuation command set or the third control actuation command set, and output a first selected control actuation command set, and select, based on at least the plurality of states for the vehicle and health status indications of the pair of computational nodes, either the second control actuation command set or the fourth control actuation command set, and output a second selected control actuation command set, and wherein the vehicle controller is configured to receive the first selected control actuation command set and the second selected control actuation command set, and control the vehicle based thereon.
16. The system of solution 15, wherein the first control actuation command set comprises a throttle command set, a brake command set, and a steering command set.
17. The system of solution 15 or 16, wherein the control arbitrator is configured to select either the second control actuation command set or the fourth control actuation command set further based on a runtime delay of the second computational node.
18. The system of solution 17, wherein the second control actuation command set is selected upon a determination that the runtime delay is greater than a threshold.
19. The system of any of solutions 15 to 18, wherein the second computational node generates the fourth control actuation command set further based on a road grade associated with one or more of the plurality of planner waypoints.
20. The system of any of solutions 15 to 19, wherein the vehicle is an autonomous vehicle is operating in a Society of Automotive Engineers Level 4 automation mode.

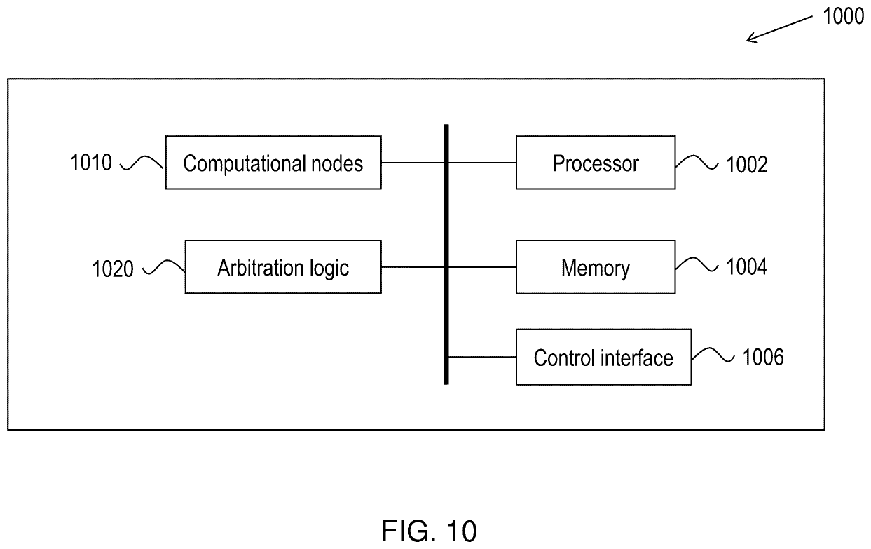

FIG. 10 shows an example of a hardware platform 1000 that can be used to implement some of the techniques described in the present document. For example, the hardware platform 1000 may implement methods 800 and 900, or may implement the various modules described herein. The hardware platform 1000 may include a processor 1002 that can execute code to implement a method. The hardware platform 1000 may include a memory 1004 that may be used to store processor-executable code and/or store data. The hardware platform 1000 may further include a control interface 1006. For example, the control interface 1006 may implement one or more intra-vehicular communication protocols. The hardware platform may further include multiple computational nodes 1010 and arbitration logic 1020, which can be implemented in an FPGA or a microcontroller. In some embodiments, some portion or all of the arbitration logic 1020 may be implemented in the processor 1002. In other embodiments, the memory 1004 may comprise multiple memories, some of which are exclusively used by the computational nodes 1010 and/or the arbitration logic 1020.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A system for controlling a vehicle, comprising:
a first computational node configured to receive a plurality of planner waypoints and a plurality of states for the vehicle, wherein the first computational node comprises:
a controller configured to receive the plurality of planner waypoints and the plurality of states and generate, using a model predictive control framework, (a) a first control algorithm for motion of the vehicle in a lateral direction, (b) a second control algorithm for motion of the vehicle in a longitudinal direction, and (c) a model predictive control reference that is decomposable into a lateral control reference and a longitudinal control reference by the model predictive control framework, wherein the first control algorithm is decoupled from the second control algorithm;
a first controller configured to generate, based on the first control algorithm, a first trajectory and a first control actuation command set for the motion of the vehicle in the lateral direction, wherein the first trajectory and the first control actuation command set is generated using an optimization solver with a first complexity; and
a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity;
a second computational node configured to receive the plurality of planner waypoints, the plurality of states for the vehicle, and the model predictive control reference, wherein the model predictive control reference is received with a first delay, and wherein the second computational node comprises:
a third controller configured to generate a third trajectory and a third control actuation command set for the motion of the vehicle in the longitudinal direction, wherein the third trajectory and the third control actuation command set is generated using the optimization solver with the first complexity;
a control arbitrator configured to receive the plurality of states for the vehicle, the second control actuation command set, and the third control actuation command set, select, based on at least the plurality of states for the vehicle and health status indications of the first and second computational nodes, either the second control actuation command set or the third control actuation command set, and output a selected control actuation command set; and
a vehicle controller configured to receive, subsequent to a second delay, the first control actuation command set and the selected control actuation command set, and control the vehicle based thereon.

2. The system of claim 1, wherein the first control actuation command set comprises a throttle command set, a brake command set, and a steering command set.

3. The system of claim 1, wherein the control arbitrator is configured to select the second control actuation command set upon a determination that the health status indication of the second computational node comprises an error condition.

4. The system of claim 1, wherein the control arbitrator is configured to select a minimal risk condition control actuation command set upon a determination that the health status indication of the first computational node comprises an error condition, and wherein the minimal risk condition control actuation command set causes the vehicle to reduce its speed and safely come to a stop.

5. The system of claim 1, wherein the first control algorithm being decoupled from the second control algorithm configures the first controller and the second controller to independently solve the first control algorithm and the second control algorithm, respectively.

6. The system of claim 1, wherein a duration of the first delay or the second delay is based on an input delay and an output delay, wherein the input delay comprises a communication time and a computation time of the first computational node and the output delay comprises a delay associated with electro-mechanical components of the vehicle.

7. The system of claim 6, wherein the output delay further comprises a computation time of the second computational node and a computation time of the control arbitrator.

8. The system of claim 1, wherein the vehicle is an autonomous vehicle is operating in a Society of Automotive Engineers Level 4 automation mode.

9. A method of controlling a vehicle, comprising:
receiving, by a first computational node, a plurality of waypoints and a plurality of states for the vehicle, wherein the first computational node comprises a controller that is configured to generate, based on the plurality of waypoints and the plurality of states for the vehicle and using a model predictive control framework, a first control algorithm for motion of the vehicle in a lateral direction and a second control algorithm for motion of the vehicle in a longitudinal direction;
generating, by the first computational node, (a) a first trajectory and a first control actuation command set for the motion of the vehicle in the lateral direction based on using an optimization solver with a first complexity and (b) a second trajectory and a second control actuation command set for the motion of the vehicle in the longitudinal direction based on using a high reliability solver with a second complexity that is less than the first complexity;
generating, by a second computational node that operates in parallel with the first computational node, a third trajectory and a third control actuation command set for the motion of the vehicle in the longitudinal direction based on using the optimization solver with the first complexity;
selecting, by a control arbitrator and based on the plurality of states for the vehicle and health status indications of the first and second computational nodes, either the second control actuation command set or the third control actuation command set, and outputting the selected control actuation command set; and
controlling, by a vehicle controller, the vehicle based on the first control actuation command set and the selected control actuation command set.

10. The method of claim 9, wherein the first control actuation command set comprises a throttle command set, a brake command set, and a steering command set.

11. The method of claim 9, wherein the control arbitrator is configured to select either the second control actuation command set or the third control actuation command set further based on a runtime delay of the second computational node.

12. The method of claim 11, wherein the second control actuation command set is selected upon a determination that the runtime delay is greater than a threshold.

13. The method of claim 9, wherein using the model predictive control framework enables (a) the first algorithm to be generated for a finite time-horizon that includes a current timeslot and (b) the first trajectory and the first control actuation command set to be generated only for the current timeslot at each timestep.

14. The method of claim 9, wherein the second computational node generates the third control actuation command set further based on a road grade associated with one or more of the plurality of waypoints.

15. A system for controlling a vehicle, comprising:
a pair of computational nodes;
a control arbitrator; and
a vehicle controller,
wherein each of the pair of computational nodes comprises a controller configured to receive a plurality of planner waypoints and a plurality of states for the vehicle and generate, using a model predictive control framework, (a) a first control algorithm for motion of the vehicle in a lateral direction, (b) a second control algorithm for motion of the vehicle in a longitudinal direction,
wherein a first computational node of the pair of computational nodes comprises:
a first controller configured to generate, based on the first control algorithm, a first trajectory and a first control actuation command set for the motion of the vehicle in the lateral direction, wherein the first trajectory and the first control actuation command set is generated using an optimization solver with a first complexity,
a second controller configured to generate, based on the second control algorithm, a second trajectory and a second control actuation command set for the motion of the vehicle in the longitudinal direction, wherein the second trajectory and the second control actuation command set is generated using a high reliability solver with a second complexity that is less than the first complexity,
wherein a second computational node of the pair of computational nodes comprises:
a third controller configured to generate, based on the first control algorithm, a third trajectory and a third control actuation command set for the motion of the vehicle in the lateral direction, wherein the third trajectory and the third control actuation command set is generated using the high reliability solver with the second complexity,
a fourth controller configured to generate, based on the second control algorithm, a fourth trajectory and a fourth control actuation command set for the motion of the vehicle in the longitudinal direction, wherein the fourth trajectory and the fourth control actuation command set is generated using the optimization solver with the first complexity,
wherein the control arbitrator is configured to:
select, based on at least the plurality of states for the vehicle and health status indications of the pair of computational nodes, either the first control actuation command set or the third control actuation command set, and output a first selected control actuation command set, and
select, based on at least the plurality of states for the vehicle and health status indications of the pair of computational nodes, either the second control actuation command set or the fourth control actuation command set, and output a second selected control actuation command set, and
wherein the vehicle controller is configured to receive the first selected control actuation command set and the second selected control actuation command set, and control the vehicle based thereon.

16. The system of claim 15, wherein the first control actuation command set comprises a throttle command set, a brake command set, and a steering command set.

17. The system of claim 15, wherein the control arbitrator is configured to select either the second control actuation command set or the fourth control actuation command set further based on a runtime delay of the second computational node.

18. The system of claim 17, wherein the second control actuation command set is selected upon a determination that the runtime delay is greater than a threshold.

19. The system of claim 15, wherein the second computational node generates the fourth control actuation command set further based on a road grade associated with one or more of the plurality of planner waypoints.

20. The system of claim 15, wherein the vehicle is an autonomous vehicle is operating in a Society of Automotive Engineers Level 4 automation mode.
